(19) United States
(12) Patent Application Publication
(10) Pub. No.: US 2023/0319679 A1
(43) Pub. Date: Oct. 5, 2023

(54) METHOD FOR PROVISION OF USER POLICY AND DEVICE PERFORMING THE SAME

(71) Applicant: ELECTRONICS AND TELECOMMUNICATIONS RESEARCH INSTITUTE, Daejeon (KR)

(72) Inventors: Jihoon SUNG, Daejeon (KR); Myung Ki SHIN, Seoul (KR); Soohwan LEE, Daejeon (KR)

(73) Assignee: ELECTRONICS AND TELECOMMUNICATIONS RESEARCH INSTITUTE, Daejeon (KR)

(21) Appl. No.: 18/190,524

(22) Filed: Mar. 27, 2023

(30) Foreign Application Priority Data
Mar. 29, 2022 (KR) 10-2022-0039028
May 6, 2022 (KR) 10-2022-0056108
May 20, 2022 (KR) 10-2022-0062186
Nov. 4, 2022 (KR) 10-2022-0146216
Nov. 23, 2022 (KR) 10-2022-0158568
Feb. 10, 2023 (KR) 10-2023-0018100
Feb. 28, 2023 (KR) 10-2023-0026754
Mar. 20, 2023 (KR) 10-2023-0035979

(51) Int. Cl. H04W 40/12

(52) U.S. Cl. CPC H04W 40/12

(57) ABSTRACT

Disclosed are a user policy provision method and a device performing the user policy provision method. A user equipment (UE) route selection policy (URSP) provision method includes requesting analytics of an analytics identifier (ID), determining a URSP rule based on an analytics result for the analytics ID, and providing the URSP rule.

### TECHNICAL FIELD

The following description relates to a user policy provision method and a device performing the method.

### BACKGROUND ART

The fifth generation (5G) mobile communication system defines a network data analytics function (NWDAF), which is a network function for analyzing data collected from 5G networks and providing the analyzed data to support network automation.

For automation and optimization of the 5G mobile communication system, the NWDAF may collect raw data of each network function and apply function to transform the raw data into big data, and process the big data to provide network analytics information.

The above description has been possessed or acquired by the inventor(s) in the course of conceiving the present disclosure and is not necessarily an art publicly known before the present application is filed.

### DISCLOSURE OF INVENTION

### Technical Solutions

An embodiment of the present disclosure provides a user equipment (UE) route selection policy (URSP) provision method, the URSP provision method including: requesting analytics of an analytics identifier (ID); determining a URSP rule based on an analytics result for the analytics ID; and providing the URSP rule.

The determining may include adjusting a precedence and one or more components of a route selection descriptor (RSD) in the URSP rule based on the analytic result for the analytics ID.

The determining may include determining a URSP applicable to UE based on a local configuration and an operator policy; and determining a URSP rule for the UE based on the analytics result for the analytics ID.

The one or more components of the RSD may include at least one of a network slice selection policy (NSSP), a DNN selection policy, an SSC mode selection policy (SSCMSP), a protocol data unit (PDU) session type policy, a non-seamless offload policy, or an access type preference.

The adjusting of the NSSP of the route selection descriptor may be associated with “load level information,” “service experience,” “dispersion analytics,” and “session management congestion control experience (SMCCE),” which are the analytics IDs.

The adjusting of the DNN selection policy of the route selection descriptor may be associated with “service experience,” “UE communication”, an “SMCCE,” and “DN performance,” which are the analytics IDs.

The adjusting of the non-seamless offload policy of the route selection descriptor may be associated with “UE communication,” “wireless local area network (WLAN) performance,” “load level information,” “network performance,” and “user data congestion,” which are the analytics IDs.

The adjusting of the SSCMSP of the route selection descriptor may be associated with “service experience” which is the analytics ID.

The adjusting of the PDU session type policy of the route selection descriptor may be associated with “service experience” which is the analytics ID.

The adjusting of the access type preference of the route selection descriptor may be associated with “service experience” and “WLAN performance,” which are the analytics IDs.

An embodiment of the present disclosure provides a device providing a URSP, the device including: a processor; and a memory electrically connected to the processor and configured to store instructions executable by the processor. When the instructions are executed by the processor, the processor is configured to perform a plurality of operations, and the plurality of operations comprises: requesting analytics of an analytics ID; determining a URSP rule based on an analytics result for the analytics ID; and providing the URSP rule.

The determining may include adjusting a precedence and one or more components of a route selection descriptor in the URSP rule based on the analytics result for the analytics ID.

The determining may include: determining a URSP applicable to UE based on a local configuration and an operator policy; and determining a URSP rule for the UE based on the analytics result for the analytics ID.

The one or more components of the RSD may include at least one of an NSSP, a DNN selection policy, an SSCMSP, a PDU session type policy, a non-seamless offload policy, or an access type preference.

The adjusting of the NSSP of the route selection descriptor may be associated with “load level information,” “service experience,” “dispersion analytics,” and “SMCCE,” which are the analytics IDs.

The adjusting of the DNN selection policy of the route selection descriptor may be associated with “service experience,” “UE communication,” “SMCCE,” and “DN performance,” which are the analytics IDs.

The adjusting of the non-seamless offload policy of the route selection descriptor may be associated with “UE communication,” “WLAN performance,” “load level information,” “network performance,” and “user data congestion,” which are the analytics IDs.

The adjusting of the SSCMSP of the route selection descriptor may be associated with “service experience” which is the analytics ID.

The adjusting of the PDU session type policy of the route selection descriptor may be associated with “service experience” which is the analytics ID.

The adjusting of the access type preference of the route selection descriptor may be associated with “service experience” and “WLAN performance,” which are the analytics IDs.

### BRIEF DESCRIPTION OF DRAWING

FIG. 1 illustrates a network system according to an embodiment.

FIG. 2 illustrates a network system according to an embodiment.

FIG. 3 illustrates an operation of determining a network data analytics function (NWDAF)-assisted user equipment (UE) route selection policy (URSP) according to an embodiment.

FIG. 4 illustrates an example operation of determining a URSP according to an embodiment.

FIG. 5 illustrates another example operation of determining a URSP according to an embodiment.

FIG. 6 illustrates a schematic block diagram of a device for performing URSP determination according to an embodiment.

### DETAILED DESCRIPTION FOR CARRYING OUT INVENTION

The following detailed structural or functional description is provided only for illustrative purposes, and various alterations and modifications may be made to examples. Here, examples are not construed as limited to the disclosure and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example, the module may be implemented in the form of an application-specific integrated circuit (ASIC).

The term “unit” or “-er/-or” used herein may refer to a software or hardware component, such as a field-programmable gate array (FPGA) or an ASIC, and the “unit” or “-er/-or” performs predefined functions. However, “unit” or “-er/-or” is not limited to software or hardware. The “unit” or “-er/-or” may be configured to reside on an addressable storage medium or configured to operate one or more processors. Accordingly, the “unit” or “-er/-or” may include, for example, components such as software components, object-oriented software components, class components, and task components, processes, functions, attributes, procedures, sub-routines, segments of program code, drivers, firmware, microcode, circuitry, data, databases (DBs), data structures, tables, arrays, and variables. The functions or functionalities provided in the components and “units” may be combined into fewer components and “units” or may be further separated into additional components and “units.” Furthermore, the components and “units” may be implemented to operate one or more central processing units (CPUs) within a device or a security multimedia card. In addition, “unit” or “-er/-or” may include one or more processors.

Hereinafter, embodiments will be described in detail with reference to the accompanying drawings. When describing the embodiments with reference to the accompanying drawings, like reference numerals refer to like components and a repeated description related thereto will be omitted.

Terms used herein to identify a connection node and indicate network entities, messages, an interface between the network entities, and various pieces of identification information are provided as examples for the convenience of description. Thus, the embodiments are not limited to terms described later in this disclosure and other terms referring to a subject having the equivalent technical meaning may be used.

For the convenience of description, terms and names defined in the long-term evolution (LTE) and new radio (NR) standards, which are the latest standards defined by the third-generation partnership project (3GPP) association, of currently existing communication standards, are used herein. However, embodiments described hereinafter are not limited to the terms and names and a system in compliance with other standards may also be applicable in the same manner.

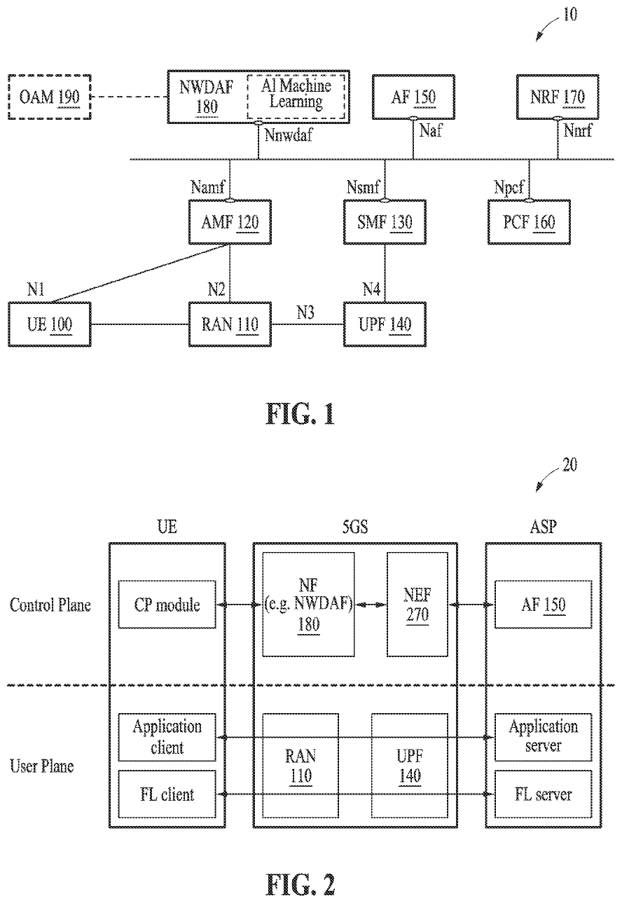

FIG. 1 illustrates a network system according to an embodiment.

Referring to FIG. 1, according to an embodiment, a network system 10 (e.g., a fifth generation (5G) network system) may include a plurality of entities 100 to 190. A user terminal or user equipment (UE) 100 may be connected to a 5G core network via a radio access network (RAN) 110. The RAN 110 may refer to a base station providing a wireless communication function to the UE 100. An operation, administration, and maintenance (OAM) 190 may be a system for managing terminals and networks.

A unit performed by each function provided by the network system 100 may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, and a network data analytics function (NWDAF) 180. The AMF 120 may manage network access and mobility of a terminal, the SMF 130 may perform a session-related function, the UPF 140 may transmit user data, and the AF 150 may communicate with 5G core (5GC) to provide an application service. The PCF 160 may manage a policy, the NRF 170 may store status information of NFs and may process a request to find an NF accessible by other NFs.

The NWDAF 180 may provide an analytics result by analyzing data collected in a network (e.g., a 5G network) to support network automation. The NWDAF 180 may collect, store, and analyze information from the network. The NWDAF 180 may collect information from the OAM 190, NFs constituting the network, or the AF 150. The NWDAF 180 may provide the analytics result to an NF, OAM, or AF. The analytics result may be independently used by each NF.

The NWDAF 180 may provide an analytics information subscription service (Nnwdaf_AnalyticsSubscription service). The analytics information subscription service may be provided to allow subscription to or unsubscription from a network data analytics result generated by the NWDAF 180. The analytics information subscription service may be divided into a method of periodically receiving a network analytics result according to a need of an NF that subscribes to the service or a method of receiving an analytics result when a predetermined condition is satisfied. The analytics information subscription service may be provided through three operations—subscribe, unsubscribe, and notify.

The subscribe operation (Nnwdaf_AnalyticsSubscription operation) may include a required input and/or an optional input. The required input may include single network slice selection assistance information (S-NSSAI), an event identifier (ID) or an analytics ID, a notification target address, and analytics reporting information. The optional input may include information additionally required for processing analytics information. For example, the optional input may include information of an event filter or an analytics filter (or an analytics information filter). However, examples are not limited thereto.

In the case of the unsubscribe operation (Nnwdaf_AnalyticsSubscription_Unsubscribe operation), an NF may transmit subscription correlation ID information to the NWDAF 180, and the NWDAF 180 may transmit, as an output, a message notifying that unsubscription is confirmed to the NF requesting the unsubscription.

The notify operation (Nnwdaf_AnalyticsSubscription_Notify operation) may be performed by the NWDAF 180 to notify an NF, which successfully subscribes to the analytics information subscription service, of a specified network data analytics result periodically or when a predetermined condition is satisfied. The notify operation may include an event ID or an analytics ID, a notification target address, an ID of a network slice instance, and load level information of a network slice instance.

The NWDAF 180 may provide an analytics information request service (Nnwdaf_AnalyticsInfo service). Unlike the analytics information subscription service, the analytics information request service may be a service in which an NF requests analytics on specific information and receives a result value immediately after the request is completed. An operation of the analytics information request service may include a request and a response. An NF requesting analytics information may transmit an analytics information request message to the NWDAF 180.

The NWDAF 180 may transmit an analytics result to the NF by which the request is made. The analytics result may be used to optimize the performance of an operation (or a network function) performed by each NF, for example, quality of service (QoS) management, traffic control, mobility management, load dispersion, and power management of a terminal.

In the network system 10, NFs excluding the NWDAF 180, for example, the RAN 110, the AMF 120, the SMF 130, the UPF 140, the AF 150, the PCF 160, the NRF 170, and/or the OAM 190, may each be a consumer NF that may request an analytics result from the NWDAF 180. Each NF may be a service consumer NF of the network data analytics service. The NWDAF 180 may collect data from each NF and analyze the data to generate an analytics result requested by a consumer NF. The NWDAF 180 may transmit the analytics result to the consumer NF that transmits a request for analytics. Accordingly, the NWDAF 180 may be a provider NF of an analytics result requested by a consumer NF. The NWDAF 180 may be a service provider NF of a service that provides an analytics result requested by a service consumer NF.

FIG. 2 illustrates a network system according to an embodiment.

Referring to FIG. 2, according to an embodiment, a network system 20 (e.g., the network system 10 of FIG. 1) may include a UE 100, a 5G system (5GS) 230, and an application service provider (ASP) 250. In the network system 20, various application service types may be supported via the 5GS 230. An artificial intelligent (AI)/machine learning (ML) service may also be one of the various application service types. Hereinafter, for the convenience of description, an example in which the AI/ML service is supported through federated learning (FL) (e.g., fault-tolerant FL) in the 5GS 230 will be described, but examples are not necessarily limited thereto. For example, AI/ML operation splitting between AI/ML entities may be another example.

In the network system 20, reliable AI/ML service(s) (e.g., on-device AI/ML service(s)) may be supported through FL in the 5GS 230. FL may include three operational stages: training device selection, model and configuration distribution, and training result reporting. After the training device selection stage (e.g., assuming that a training device is appropriately selected by an FL server), the FL server included in the ASP 250 may distribute a global model to the training device (e.g., the training device selected by the FL server), and the training device may perform local training based on the global model. When the local training is completed, the training device may upload a local training result to the FL server. A series of operations described above in FL may be performed iteratively. In a next iteration, a new device may be added to an FL group for training, or some existing training device(s) may be excluded from the FL group as needed.

The AI/ML service may operate in an application layer. An application client of the UE 100 and an application server of the ASP 250 may be in charge of processing typical application layer operations such as general data traffic transmission and reception for service(s) provided by an application. Data traffic may pass through a RAN (e.g., the RAN 110 of FIG. 1) and a UPF (e.g., the UPF 140 of FIG. 1) in a user plane (UP) of the 5GS 230. Since an FL client of the UE 100 and the FL server of the ASP 250 perform dedicated tasks for model training in the application layer, information on FL operations between the FL client and the FL server may be exchanged through the UP. Depending on an application architecture, the FL client and the FL server may belong to the application client of the UE 200 and the application server of the ASP 250, respectively. The FL operation (s) may be performed in the UP, but UP operation(s) may be directly affected by a method (or scheme) controlled by a control plane (CP).

According to an embodiment, a policy (e.g., an NWDAF-assisted UE route selection policy (URSP)) may support stable transmission of trained model information between the FL server and the training device for fault-tolerant learning. The policy may include a URSP and/or a radio access technology (RAT)/frequency selection policy (RFSP). The policy may contribute to maximally successful delivery of the trained model information for FL service(s) (e.g., fault-tolerant FL service(s)).

The PCF 160 may provide an NWDAF-assisted URSP. The PCF 160 may provision a URSP suitable for an FL operation such that model distribution and upload are completed as normally as possible.

The PCF 160 may generate a URSP rule based on various information of the PCF 160 (e.g., an analytics result for an “analytics ID” received from the NWDAF 180) and/or operator policy. For example, the PCF 160 may generate the URSP rule based on the operator policy and the analytics result for the “analytics ID” received from the NWDAF 180. For another example, the PCF 160 may generate the URSP rule based on the operator policy, and update the URSP such that the URSP is suitable for a fault-tolerant FL operation based on the analytics result for the “analytics ID” received from the NWDAF 180.

The PCF 160 may determine analytics on the “analytics ID” to be used for the URSP suitable for the fault-tolerant FL operation. A specific NF (e.g., the PCF 160 and/or the AF 150) may request or subscribe to the NWDAF 180 for the analytics on the “analytics ID.”

As a similar approach to the NWDAF-assisted URSP, an NWDAF-assisted RFSP may be used to support the fault-tolerant FL operation. While the NWDAF-assisted URSP may be used to update the URSP rule distributed to UE, the NWDAF-assisted RFSP may be used to update an AM policy (e.g., an RFSP index) used by the AMF 120 to perform radio resource management functionality.

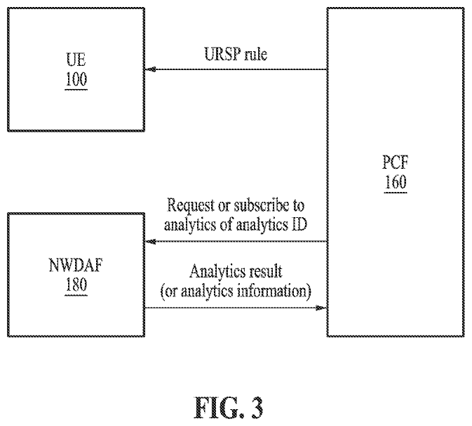

FIG. 3 illustrates an operation of determining an NWDAF-assisted URSP according to an embodiment.

Referring to FIG. 3, the PCF 160 may determine a URSP rule for the UE 100 applicable to the UE 100 and provide the URSP rule to the UE 100. The UE 100 may be provisioned (signaled) with the URSP rule determined by the PCF 160. When the UE 100 is roaming, the PCF 160 may update the URSP rule of the UE 100. The UE 100 may support provisioning (signaling) of the PCF 160 (e.g., may support as specified in TS 24.501). Additionally, the UE 100 may be pre-configured (e.g., by an operator) with the URSP rule.

The PCF 160 may request or subscribe to analytics on an analytics ID (e.g., an analytics ID specified in TS 23.288), and receive a notification (e.g., a notification of an analytics result of an analytics ID). The analytics ID may include load information (e.g., load level information), service experience, network performance, abnormal behavior, UE mobility, UE communication, user data congestion, dispersion analytics, wireless local area network (WLAN) performance, session management congestion control experience (SMCCE), DN (data network) performance, and redundant transmission experience.

The PCF 160 may make a policy decision through network analytics-based policy decisions. The PCF 160 may make the policy decision based on the analytics result for the analytics ID (e.g., analytics information defined for the analytics ID). The analytics result may be provided directly from the NWDAF 180 or provided through a data collection coordination function (DCCF) according to an arrangement of the NWDAF 180 and/or the DCCF. The PCF 160 may use a DCCF service and a DCCF service operation to fetch, subscribe to, and unsubscribe from the analytics ID.

An analytics ID relevant to the policy decision among analytics IDs (e.g., analytics IDs specified in TS 23.288) may include load information (e.g., load level information), service experience, network performance, abnormal behavior, UE mobility, UE communication, user data congestion, dispersion analytics, WLAN performance, SMCCE, DN performance, and redundant transmission experience.

The PCF 160 may subscribe to the NWDAF 180. The PCF 160 may subscribe to a notification of network analytics associated with an analytics ID. The PCF 160 may subscribe to the NWDAF 180 using a Nnwdaf_AnalyticsSubscription_Subscribe service operation. When requesting the Nnwdaf_AnalyticsSubscription_Subscribe service operation, the request may include the analytics ID. When requesting the Nnwdaf_AnalyticsSubscription_Subscribe service operation, the request may further include various information according to the analytics ID. The PCF 160 may subscribe to the NWDAF 180 using ae a Ndccf_DataManagement_Subscribe service operation. The Ndccf_DataManagement_Subscribe service operation may include an “analytics specification,” along with information included in Nnwdaf_AnalyticsSubscription_Subscribe.

An example of subscribing to a notification of “service experience”-related network analytics will be described. The PCF 160 may subscribe to a network analytics notification associated with a “service experience” using the Nnwdaf_AnalyticsSubscription_Subscribe service operation. In this case, the Nnwdaf_AnalyticsSubscription_Subscribe service operation may include an analytics ID “service experience,” a target of analytics reporting (e.g., including “subscription permanent ID (SUPI),” “internal group ID,” and/or “any UE”), one or more values of an analytics filter (e.g. one or more application IDs, one or more “any” RAT types or frequency values, each RSC (e.g. S-NSSAI, DNN, PDU session type, SSC mode, access type), and analytics reporting information (e.g., set as a service experience threshold value for RAT type and/or frequency value). The PCF 160 may receive a notification of service experience statistics or predictions including a first list (e.g., a list of SUPIs to which the “service experience” is provided) and a second list (e.g., a list of RAT types and/or frequency values to which the “service experience” is applied) for each application ID. In addition, both spatial and time validity may also be provided in addition to confidence of the predictions.

An example of subscribing to a notification of “SMCCE”-related network analytics will be described. The PCF 160 may subscribe to such a network analytics notification associated with “SMCCE” using the Nnwdaf_AnalyticsSubscription_Subscribe service operation. In this case, the Nnwdaf_AnalyticsSubscription_Subscribe service operation may include “SMCCE” of an analytics ID, a target (e.g., including “SUPI”) of analytics reporting, and an analytics filter (e.g., including DNN and/or S-NSSAI). The PCF 160 may receive a notification of SMCCE statistics including DNN and/or S-NSSAI.

An example of subscribing to a notification of “DN performance”-related network analytics will be described. The PCF 160 may subscribe to a network analytics notification associated with “DN Performance,” using the Nnwdaf_AnalyticsSubscription_Subscribe service operation. In this case, the Nnwdaf_AnalyticsSubscription_Subscribe service operation may include “DN performance” of an analytics ID, a target (e.g., including “SUPI,” “internal group ID,” and/or “any UE”) of analytics reporting, and analytics filter (e.g., including application ID(s)). The PCF 160 may receive a notification of DN performance statistics or predictions including an application ID. In addition, confidence of the predictions may be provided.

The PCF 160 may subscribe to analytics information from the NWDAF 180 in response to a trigger. The trigger may include one or more among a request from an AF (e.g., the AF 150 of FIG. 1)/network exposure function (NEF), an AM policy association establishment or modification request from an AMF (e.g., the AMF 120 of FIG. 1), a UE policy association establishment or modification request, an SM policy association establishment or modification request from an SMF (e.g., the SMF 130 of FIG. 1), a notification received from a unified data repository (UDR) or a charging function (CHF) for an UE subscription change, and analytics information reception.

The trigger condition may vary according to an operator in the PCF 160 and an implementation policy. When the trigger (or the trigger condition) occurs, the PCF 160 may check a local configuration or evaluate an operator policy to determine whether an analytics result (or analytics information) is required. When the analytics result is required, the PCF 160 may initiate a subscription to the analytics information directly from the NWDAF 180 or via the DCCF (e.g., if distributed).

The PCF 160 may subscribe to an analytics ID directly from the NWDAF 180 or via the DCCF (e.g., if distributed) according to the trigger, to generate or update a URSP (e.g., to adjust fields (e.g., RSC) in a URSP rule and/or RSD precedence.

The PCF 160 may determine a URSP rule for the UE 100 that is applicable to the UE 100. For example, the PCF 100 may determine policy information (e.g., a URSP) applicable to each UE 100 based on a local configuration and an operator policy, and may also determine the URSP rule for the UE 100 based on network analytics from the NWDAF 180.

The URSP may include one or more URSP rules. A URSP rule may include a traffic descriptor (e.g., specifying matching criteria) and one or more components. The URSP may further include a prioritized list of the URSP rule(s). The components may include an SSC mode selection policy (SSCMSP), a network slice selection policy (NSSP), a DNN selection policy, a PDU session type policy, a non-seamless offload policy, an access type preference, a ProSe Layer-3 UE-to-network relay offload policy, a PDU session pair ID, and/or an RSN. Table 1 below relates to URSPs, and Tables 2 and 3 relate to examples of the structure of URSP rules.

TABLE 1
URSP

| | | | PCF permitted | |
|---|---|---|---|---|
| Information | | | to modify | |
| name | Description | Category | in a URSP | Scope |
| URSP rules | One or more URSP | Mandatory | Yes | UE |
| | rules as specified | | | context |
| | in table 2 | | | |

TABLE 2
URSP rules

| | | | PCF permitted to | |
|---|---|---|---|---|
| | | | modify in a UE | |
| Information name | Description | Category | context | Scope |
| Rule Precedence | Determines the order the | Mandatory | Yes | UE context |
| | URSP rule is enforced in | (NOTE 1) | | |
| | the UE. | | | |
| Traffic descriptor | This part defines the | Mandatory | | |
| | Traffic descriptor | (NOTE 3) | | |
| | components for the URSP | | | |
| | rule. | | | |
| Application descriptors | It consists of OSId and | Optional | Yes | UE context |
| | OSAppId(s). (NOTE 2) | | | |
| IP descriptors (NOTE | Destination IP 3 tuple(s) | Optional | Yes | UE context |
| 5) | (IP address or IPv6 | | | |
| | network prefix, port | | | |
| | number, protocol ID of the | | | |
| | protocol above IP). | | | |
| Domain descriptors | FQDN(s) or a regular | Optional | Yes | UE context |
| | expression which are used | | | |
| | as a domain name | | | |
| | matching criteria (NOTE | | | |
| | 6). | | | |
| Non-IP descriptors | Descriptor(s) for | Optional | Yes | UE context |
| (NOTE 5) | destination information of | | | |
| | non-IP traffic | | | |
| DNN | This is matched against | Optional | Yes | UE context |
| | the DNN information | | | |
| | provided by the | | | |
| | application. | | | |
| Connection Capabilities | This is matched against | Optional | Yes | UE context |
| | the information provided | | | |
| | by a UE application when | | | |
| | it requests a network | | | |
| | connection with certain | | | |
| | capabilities. (NOTE 4) | | | |
| Rule Precedence | Determines the order the | Mandatory | Yes | UE context |
| | URSP rule is enforced in | (NOTE 1) | | |
| | the UE. | | | |
| List of Route | A list of Route Selection | Mandatory | | |
| Selection Descriptors | Descriptors. The | | | |
| | components of a Route | | | |
| | Selection Descriptor are | | | |
| | described in table 3. | | | |

(NOTE 1):
Rules in a URSP shall have different precedence values.
(NOTE 2):
The information is used to identify the Application(s) that is(are) running on the UE's OS. The OSId does not include an OS version number. The OSAppId does not include a version number for the application.
(NOTE 3):
At least one of the Traffic descriptor components shall be present.
(NOTE 4):
The format and some values of Connection Capabilities, e.g., “ims,” “mms,” “internet,” etc., are defined in TS 24.526. More than one connection capabilities value can be provided.
(NOTE 5):
A URSP rule cannot contain the combination of the Traffic descriptor components IP descriptors and Non-IP descriptors.
(NOTE 6):
The match of this traffic descriptor does not require successful DNS resolution of the FQDN provided by the UE Application.

TABLE 3
Route Selection Descriptor

| | | | PCF permitted | |
|---|---|---|---|---|
| | | | to modify in | |
| Information name | Description | Category | URSP | Scope |
| Route Selection | Determines the order in which | Mandatory | Yes | UE context |
| Descriptor | the Route Selection | (NOTE 1) | | |
| Precedence | Descriptors are to be applied. | | | |
| Route selection | This part defines the route | Mandatory | | |
| components | selection components | (NOTE 2) | | |
| SSC Mode Selection | One single value of SSC | Optional | Yes | UE context |
| | mode. (NOTE 5) | | | |
| Network Slice | Either a single value or a list of | Optional | Yes | UE context |
| Selection | values of S-NSSAI(s). | (NOTE 3) | | |
| DNN Selection | Either a single value or a list of | Optional | Yes | UE context |
| | values of DNN(s). | | | |
| PDU Session Type | One single value of PDU | Optional | Yes | UE context |
| Selection | Session Type | (NOTE 8) | | |
| Non-Seamless | Indicates if the traffic of the | Optional | Yes | UE context |
| Offload indication | matching application is to be | (NOTE 4) | | |
| | offloaded to non-3GPP access | | | |
| | outside of a PDU Session. | | | |
| ProSe Layer-3 UE-to- | Indicates if the traffic of the | Optional | Yes | UE context |
| Network Relay | matching application is to be | (NOTE 4) | | |
| Offload indication | sent via a ProSe Layer-3 UE- | | | |
| | to-Network Relay outside of a | | | |
| | PDU session. | | | |
| Access Type | Indicates the preferred Access | Optional | Yes | UE context |
| preference | Type (3GPP or non-3GPP or | | | |
| | Multi-Access) when the UE | | | |
| | establishes a PDU Session for | | | |
| | the matching application. | | | |
| PDU Session Pair ID | An indication shared by | Optional | Yes | UE context |
| | redundant PDU Sessions as | | | |
| | described in clause 5.33.2.1 of | | | |
| | TS 23.501 [2]. | | | |
| RSN | The RSN as described in | Optional | Yes | UE context |
| | clause 5.33.2.1 of TS 23.501 | | | |
| | [2]. | | | |
| Route Selection | This part defines the Route | Optional | | |
| Validation Criteria | Validation Criteria components | | | |
| (NOTE 6) | | | | |
| Time Window | The time window when the | Optional | Yes | UE context |
| | matching traffic is allowed. The | | | |
| | RSD is not considered to be | | | |
| | valid if the current time is not | | | |
| | in the time window. | | | |
| Location Criteria | The UE location where the | Optional | Yes | UE context |
| | matching traffic is allowed. The | | | |
| | RSD rule is not considered to | | | |
| | be valid if the UE location does | | | |
| | not match the location criteria. | | | |

(NOTE 1):
Every Route Selection Descriptor in the list shall have a different precedence value.
(NOTE 2):
At least one of the route selection components shall be present.
(NOTE 3):
When the Subscription Information contains only one S-NSSAI in UDR, the PCF needs not provision the UE with S-NSSAI in the Network Slice Selection information. The “match all” URSP rule has one S-NSSAI at most.
(NOTE 4):
If this indication is present in a Route Selection Descriptor, no other components shall be included in the Route Selection Descriptor.
(NOTE 5):
The SSC Mode 3 shall only be used when the PDU Session Type is IP.
(NOTE 6):
The Route Selection Descriptor is not considered valid unless all the provided Validation Criteria are met.
NOTE 7:
In this Release of specification, inclusion of the Validation Criteria in Roaming scenarios is not considered.
(NOTE 8):
When the PDU Session Type is “Ethernet” or “Unstructured”, this component shall be present.

Each URSP rule may include a traffic descriptor that determines a time at which the rule is applied. A URSP rule may be determined to be applicable when all components of the traffic descriptor match corresponding information from an application.

Each URSP rule may include a list (e.g., a list of route selection descriptors) including one or more route selection descriptors, each having a different route selection descriptor precedence value. There may be one or more route selection descriptors as shown in Table 3.

The PCF 160 may determine the URSP rule for the UE 100 by adjusting the route selection descriptor and/or related components of the route selection descriptor (e.g., components that may be determined by analytics ID(s)) based on network analytics (e.g., an analytics result for the analytics ID) from the NWDAF 180. Table 4 shows analytics IDs requested by the PCF 160 to the NWDAF 180 to adjust a field in the URSP (e.g., a field in the route selection descriptor).

TABLE 4
Mapping Relationship between Analytics ID and Field in URSP

| | |
|---|---|
| URSP field | Analytics ID(s) |

Route Selection Components

| | |
|---|---|
| S-NSSAI | “Service Experience,” “Load level information,” |
| | “Dispersion Analytics,” “Session Management |
| | Congestion Control Experience” |
| DNN | “Service Experience,” “UE Communication,” “Session |
| | Management Congestion Control Experience,” “DN |
| | Performance” |
| Non-Seamless | “UE Communication,” “WLAN performance,” “Load |
| Offload | level information,” “Network Performance,” “User |
| Indication | Data Congestion” |
| SSC Mode | “Service Experience” |
| PDU Session | “Service Experience” |
| type | |
| Access Type | “Service Experience,” “WLAN Performance” |
| Preference | |

Route Selection Validation Criteria

| | |
|---|---|
| Time Window | Based on the validity period and spatial validity provided |
| | in the Analytics ID(s) used for RSD generation |
| Location | Based on the validity period and spatial validity provided |
| Criteria | in the Analytics ID(s) used for RSD generation |

An example operation of determining a URSP, for example, using single network analytics information, will be described.

Based on a notification of “load information (e.g., load level information)” for a network slice (e.g., a notification of an analytics result), the PCF 160 may assign a precedence to an application to consider the lowest load, and determine (e.g., update) a URSP for a network slice selection policy. In addition, the PCF 160 may adjust a network slice selection component (e.g., a network slice with the lowest load) of a route selection descriptor in the URSP rule based on an analytics result.

The PCF 160 may use network analytics for a “service experience” for an application ID and “any RAT type” and/or “any frequency value,” to determine an RFSP index value for executing the application. In addition, the PCF 160 may adjust the network slice selection component (e.g., a network slice with the lowest load) and a DN selection (e.g., DNN(s) providing the best service experience to a specific application) component of the route selection descriptor in the URSP rule, based on the analytics result.

Based on “dispersion analytics” statistics or predictions of data volume analytics in a network slice, the PCF 160 may calculate an average data rate of the network slice and determine (e.g., update) the URSP for the network slice selection policy for related UE. The PCF 160 may adjust the network slice selection (e.g., a network slice with low data volume dispersion) component of the route selection descriptor in the URSP rule.

Based on the “SMCCE” statistics or predictions for PDU session(s) associated with S-NSSAI(s) or DNN for UE, the PCF 160 may preferentially consider an S-NSSAI or DNN that provides the lowest level of experience, and determine (e.g., update) a URSP for the network slice selection policy and/or the DNN selection policy for UE. The PCF 160 may adjust the network slice selection (e.g., a network slice that provides the lowest level of SMCCE among candidate network slices indicated by analytics filter information) and the DNN selection (e.g., a DNN that provides the lowest level of SMCCE from among candidate DNNs indicated by the analytics filter information) components, based on the analytics result.

Based on “network performance” statistics or predictions for gNB status information, gNB resource usage, communication performance, and mobility performance in an area of interest (AOI), the PCF 160 may consider offloading the number of UEs located in the AOI and determine (e.g., update) a URSP for a non-seamless offload policy for related UE.

Based on “user data congestion” statistics or predictions, which include a list of applications contributing the most to traffic, the PCF 160 may consider offloading traffic to non-3GPP access for a corresponding application, and determine (e.g., update) a URSP for the non-seamless offload policy for the application.

Based on “DN performance” statistics or predictions of user plane (or UP) performance for an application, the PCF 160 may consider a DNN with high performance and determine (e.g., update) a URSP for the DNN selection policy for the application. The PCF 160 may adjust a DNN selection (e.g., a DNN that provides the best service experience for the application) component of the route selection descriptor in the URSP rule based on the analytics result.

Based on “UE communication” statistics or predictions, the PCF 160 may consider a DNN considering traffic characterization and associated traffic volume and spatial validity and inactivity time, and determine (e.g., update) a URSP for the DNN selection policy for related UE. The PCF 160 may adjust a DNN selection (e.g., DNN(s) that provide the lowest UL/DL traffic volume) component of the route selection descriptor in the URSP rule based on the analytics result.

Another example operation of determining a URSP, for example, using a plurality of sets of network analytics information, will be described.

The PCF 160 may use an analytics results from an NWDAF to select an appropriate value of a URSP rule provided to UE, based on UE policy association establishment/modification: “load level information,” “service experience,” “network performance,” “abnormal behavior,” “UE mobility,” “UE communication,” “user data congestion,” “data dispersion,” “SMCCE,” “DN performance,” “user data congestion,” and “WLAN performance” statistics or predictions.

Based on a spatial validity notification for an application program in use provided in “UE communication” analytics, the PCF 160 may request “WLAN performance” analytics for an AOI derived from spatial validity of the “UE communication” analytics, and determine (e.g., update) the URSP for the non-seamless offload policy for associated UE.

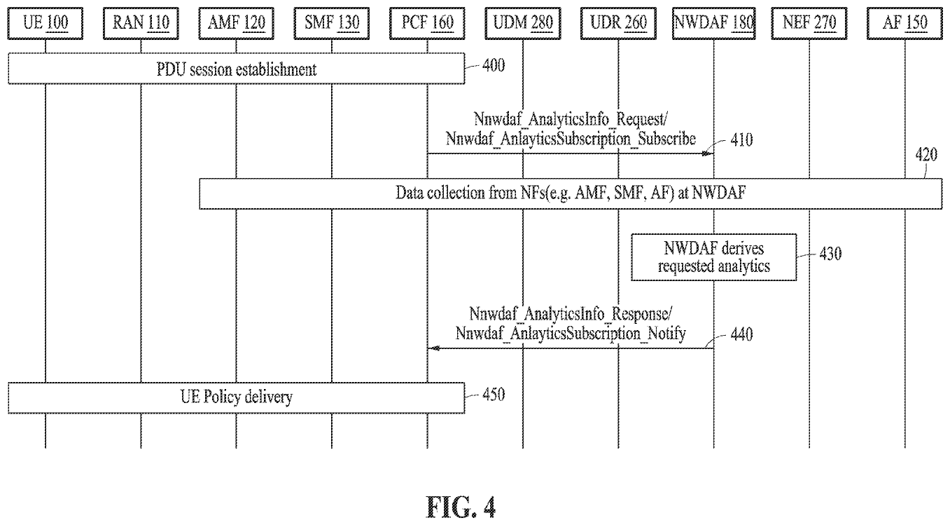

FIG. 4 illustrates an example operation of determining a URSP according to an embodiment.

As illustrated in FIG. 4, there may be a case in which analytics for an analytics ID is requested directly by the PCF 160.

In operation 400, a protocol data unit (PDU) session may be established (or set). For example, the UE 100 may establish the PDU session with an application server within the ASP 250. The application server may trigger the UE 100 to establish a new dedicated PDU session for a training task through a user plane (UP) under a condition that the consent of the UE 100 is granted. The UE 100 may establish the new PDU session in an FL server of the ASP 250. The FL server may collect information necessary for training from the UE 100 through the PDU session.

In operation 410, the PCF 160 may request (e.g., Nnwdaf_AnalyticsInfo_Request) or subscribe to (e.g., Nnwdaf_AnalyticsSubscription_Subscribe) analytics information (e.g., a service experience and a service in use) from the NWDAF 180.

In operation 420, in response to the request (e.g., Nnwdaf_AnalyticsInfo_Request) or subscription (e.g., Nnwdaf_AnalyticsSubscription_Subscribe), the NWDAF 180 may collect data necessary for deriving the requested analytics from various NFs (e.g., the AMF 120, the SMF 130, and/or the AF 150).

In operation 430, the NWDAF 180 may derive a result for the requested analytics and check notification condition(s) (e.g., by a reporting threshold).

In operation 440, the NWDAF 180 may provide the PCF 160 with a response to or a notification of the requested analytics.

In operation 450, the PCF 160 may initiate UE policy delivery.

Each time analytics for a new analytics ID is requested by the PCF 160, operations 410 through 450 may be repeated.

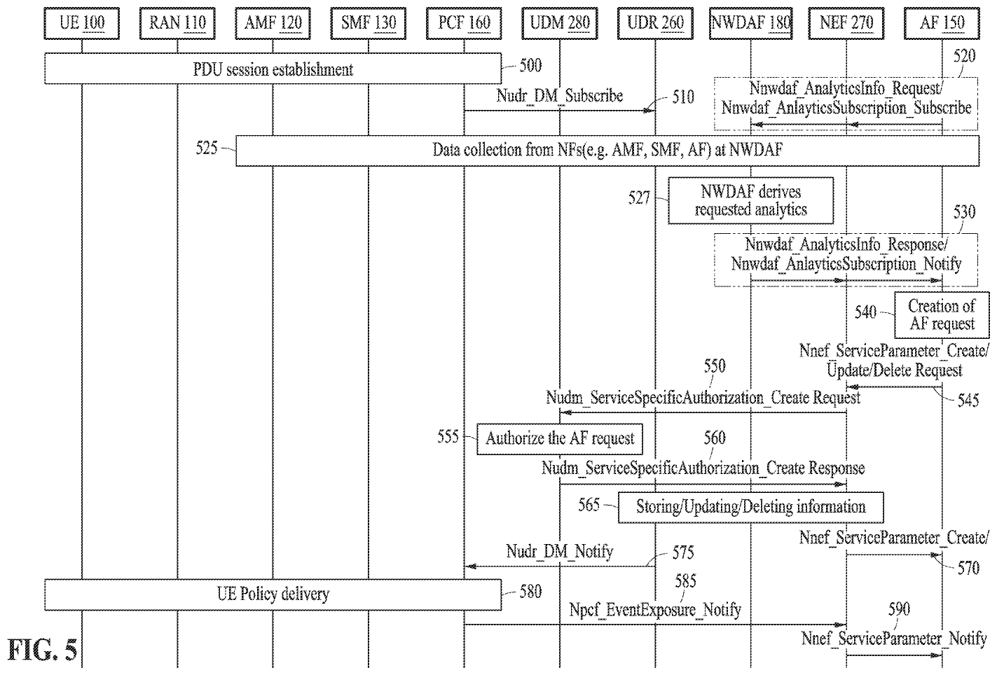

FIG. 5 illustrates another example operation of determining a URSP according to an embodiment.

As illustrated in FIG. 5, there may be a case in which analytics for an analytics ID is requested indirectly by the AF 150.

In operation 500, a PDU session may be established (or set). For example, the UE 100 may establish a PDU session with an application server within the ASP 250. The application server may trigger the UE 100 to establish a new dedicated PDU session for a training task through a user plane (UP) under a condition that the consent of the UE 100 is granted. The UE 100 may establish the new PDU session in an FL server of the ASP 250. The FL server may collect information necessary for training from the UE 100 through the PDU session.

In operation 510, the PCF 160 may subscribe to a notification of modified data in a UDR 260 by calling a Nudr_DM_Subscribe service operation. Data in the UDR 260 may be modified at any time for various reasons (e.g., a request from the AF 150).

In operation 520, the AF 150 may request (e.g., Nnwdaf_AnalyticsInfo_Request) or subscribe to (e.g., Nnwdaf_AnalyticsSubscription_Subscribe) analytics information (e.g., a service experience and a service in use) from the NWDAF 180. An NEF 270 may be used when the AF 150 is a third party and is thus unreliable.

In operation 525, in response to the request (e.g., Nnwdaf_AnalyticsInfo_Request) or subscription (e.g., Nnwdaf_AnalyticsSubscription_Subscribe), the NWDAF 180 may collect data necessary for deriving the requested analytics from various NFs (e.g., the AMF 120, the SMF 130, and/or the AF 150).

In operation 527, the NWDAF 180 may derive an analytics result for the requested analytics and check notification condition(s) (e.g., by a reporting threshold).

In operation 530, the NWDAF 180 may provide the AF 150 with a response to or a notification of the requested analytics.

In operation 540, the AF 150 may generate a new request for provisioning a service-specific parameter (e.g., AF guidance for URSP determination (refer to TS23.502 clause 4.15.6.10)) by calling a Nnef_ServiceParameter_Create service operation to provide a better quality of service to the UE 100. In addition, the AF 150 may update or delete an existing request by calling a Nnef_ServiceParameter_Update or Nnef_ServiceParameter_Delete service operation with a corresponding transaction reference ID provided by the AF 150 in a Nnef_ServiceParameter_Create response message.

In operation 545, the AF 150 may transmit the request (e.g., the new request for service-specific parameter provisioning to the NEF 270 by calling a Nnef_ServiceParameter service (e.g., a Nnef_ServiceParameter_Create/Update/Delete service operation).

In operation 550, the NEF 270 may transmit, to a unified data management (UDM) 280, a Nudm_ServiceSpecificAuthorisation_Create request. The Nudm_ServiceSpecificAuthorisation_Create request may include an S-NSSAI/DNN and a service type. The S-NSSAI/DNN and the service type may be received from the AF 150.

In operation 555, when the request is for an individual UE, the UDM 280 may check an S-NSSAI/DNN list (e.g., an S-NSSAI/DNN list for the UE 100) and other service information. The S-NSSAI/DNN list may be a list of subscribed S-NSSAI/DNNs for the UE 100. When the request is for a group of UEs, the UDM 280 may check group data (e.g., S-NSSAI/DNN group data) and other service information.

In operation 560, the UDM 280 may respond to the NEF 270 with a Nudm_ServiceSpecificAuthorisation_Create Response along with a service authorization result (e.g., an authorization result for the service authorization requested in operation 550). When the service authentication result is unsuccessful, the UDM 280 may return a negative response to the NEF 270 with an appropriate error code, and the NEF 270 may reject the request along with an appropriate error code to notify the AF 150 of such an unauthorized request. When the service authentication result is successful, the NEF 270 may perform mapping task(s) as follows.
Map an external application ID to a corresponding application ID known in 5GC
Map a generic public subscription ID (GPSI) in a target UE ID to a subscription permanent ID (SUPI), according to information received from the UDM 280
Map an external group ID in a target UE ID to an internal group ID, according to information received from the UDM 280.

For Nnef_ServiceParameter_Create, the NEF 270 may assign a transaction reference ID to the Nnef_ServiceParameter_Create request.

In operation 565, in a case of Nnef_ServiceParameter_Create or Update, the NEF 270 may store AF request information along with the assigned transaction reference ID in the UDR 260 (e.g., store “application data” (set data subset as “service-specific information”). In a case of Nnef_ServiceParameter_Delete, the NEF 270 may delete the AF request information from the UDR 260.

In operation 570, the NEF 270 may respond to the AF 150. In a case of Nnef_ServiceParameter_Create Response, a response message may include the assigned transaction reference ID.

In operation 575, the PCF 160 may receive a notification of a data change from the UDR 260 through a Nudr_DM_Notify service operation.

In operation 580, the PCF 160 may initiate UE policy delivery.

In operation 585, when the AF 150 subscribes to a notification of an outcome of the UE policy delivery and the PCF 160 is notified of a UE policy container from the AMF 120, the PCF 160 may notify the NEF 270 of such a UE policy delivery result included in the UE policy container as a result of a procedure by Npcf_EventExposure_Notify.

When the PCF 160 is notified of a UE policy delivery failure by the AMF 120 because the UE 100 is not reachable, the PCF 160 may determine to attempt to perform again operation 575 when the UE 100 is reachable. In such a case, the PCF 160 may report a temporary state (e.g., UE is temporarily unreachable as a result of a procedure for the NEF 270 by Npcf_EventExposure_Notify). When the PCF 160 determines the UE policy delivery failure, the PCF 160 may notify the NEF 270 of the failure as a result through Npcf_EventExposure_Notify.

In operation 590, when the NEF 270 receives Npcf_EventExposure_Notify, the NEF 270 may perform a mapping task (e.g., an AF transaction internal ID related to a notification correlation ID for the AF transaction ID, a SUPI for a GPSI, etc.), and trigger transmission of an appropriate message of Nnef_ServiceParameter_Notify.

Each time analytics for a new analytics ID is requested by the AF 150, operations 520 to 590 may be repeated.

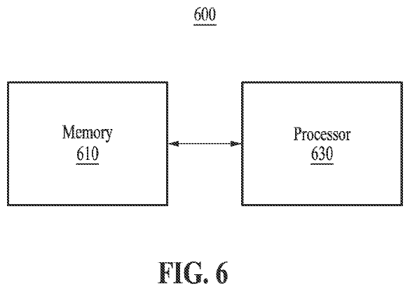

FIG. 6 illustrates a schematic block diagram of a device for performing URSP determination according to an embodiment.

Referring to FIG. 6, according to an embodiment, a device 600 (e.g., a server device) that determines a URSP rule may be substantially the same as the PCF 160 described above with reference to FIGS. 1 through 5. The device 600 may include a memory 610 and a processor 630.

The memory 610 may store instructions (or programs) executable by the processor 630. For example, the instructions may include instructions for executing an operation of the processor 630 and/or instructions for executing an operation of each component of the processor 630.

The memory 610 may be embodied as a volatile or nonvolatile memory device. The volatile memory device may be implemented as a dynamic random-access memory (DRAM), a static RAM (SRAM), a thyristor RAM (T-RAM), a zero capacitor RAM (Z-RAM), or a twin transistor RAM (TTRAM). The nonvolatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, and/or insulator resistance change memory.

The processor 630 may execute a computer-readable code (e.g., software) stored in the memory 610 and instructions triggered by the processor 630. The processor 630 may be a hardware-implemented data processing device having a physically structured circuit for executing desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

Operations performed by the processor 630 may be substantially the same as those of the PCF 160 described above with reference to FIGS. 1 through 5. Thus, a further description thereof is not repeated herein.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

1. A user equipment (UE) route selection policy (URSP) provision method, comprising:
requesting analytics of an analytics identifier (ID);
determining a URSP rule based on an analytics result for the analytics ID; and
providing the URSP rule.

2. The URSP provision method of claim 1, wherein the determining comprises:
adjusting a precedence and one or more components of a route selection descriptor in the URSP rule based on the analytics result for the analytics ID.

3. The URSP provision method of claim 1, wherein the determining comprises:
determining a URSP applicable to UE based on a local configuration and an operator policy; and
determining a URSP rule for the UE based on the analytics result for the analytics ID.

4. The URSP provision method of claim 2, wherein the one or more components comprise at least one of:
a network slice selection policy (NSSP), a DNN (data network name) selection policy, an SSC (session and service continuity) mode selection policy (SSCMSP), a protocol data unit (PDU) session type policy, a non-seamless offload policy, or an access type preference.

5. The URSP provision method of claim 2, wherein the adjusting of an NSSP of the route selection descriptor is associated with load level information, a service experience, dispersion analytics, and a session management congestion control experience (SMCCE), which are the analytics ID.

6. The URSP provision method of claim 2, wherein the adjusting of a DNN selection policy of the route selection descriptor is associated with a service experience, UE communication, an SMCCE, and DN performance, which are the analytics ID.

7. The URSP provision method of claim 2, wherein the adjusting of a non-seamless offload policy of the route selection descriptor is associated with UE communication, wireless local area network (WLAN) performance, load level information, network performance, and user data congestion, which are the analytics ID.

8. The URSP provision method of claim 2, wherein the adjusting of an SSCMSP of the route selection descriptor is associated with a service experience which is the analytics ID.

9. The URSP provision method of claim 2, wherein the adjusting of a PDU session type policy of the route selection descriptor is associated with a service experience which is the analytics ID.

10. The URSP provision method of claim 2, wherein the adjusting of an access type preference of the route selection descriptor is associated with a service experience and WLAN performance, which are the analytics ID.

11. A device providing a user equipment (UE) route selection policy (URSP), comprising:
a processor; and
a memory electrically connected to the processor and configured to store instructions executable by the processor,
wherein, when the instructions are executed by the processor, the processor is configured to perform a plurality of operations,
wherein the plurality of operations comprises:
requesting analytics of an analytics identifier (ID);
determining a URSP rule based on an analytics result for the analytics ID; and
providing the URSP rule.

12. The device of claim 11, wherein the determining comprises:
adjusting a precedence and one or more components of a route selection descriptor in the URSP rule based on the analytics result for the analytics ID.

13. The device of claim 11, wherein the determining comprises:
determining a URSP applicable to UE based on a local configuration and an operator policy; and
determining a URSP rule for the UE based on the analytics result for the analytics ID.

14. The device of claim 12, wherein the one or more components comprise at least one of:
a network slice selection policy (NSSP), a DNN selection policy, an SSC mode selection policy (SSCMSP), a protocol data unit (PDU) session type policy, a non-seamless offload policy, or an access type preference.

15. The device of claim 12, wherein the adjusting of an NSSP of the route selection descriptor is associated with load level information, a service experience, dispersion analytics, and a session management congestion control experience (SMCCE), which are the analytics ID.

16. The device of claim 12, wherein the adjusting of a DNN selection policy of the route selection descriptor is associated with a service experience, UE communication, an SMCCE, and DN performance, which are the analytics ID.

17. The device of claim 12, wherein the adjusting of a non-seamless offload policy of the route selection descriptor is associated with UE communication, wireless local area network (WLAN) performance, load level information, network performance, and user data congestion, which are the analytics ID.

18. The device of claim 12, wherein the adjusting of an SSCMSP of the route selection descriptor is associated with a service experience which is the analytics ID.

19. The device of claim 12, wherein the adjusting of a PDU session type policy of the route selection descriptor is associated with a service experience which is the analytics ID.

20. The device of claim 12, wherein the adjusting of an access type preference of the route selection descriptor is associated with a service experience and WLAN performance, which are the analytics ID.
